(19) United States
(12) Patent Application Publication
(10) Pub. No.: US 2011/0084993 A1
(43) Pub. Date: Apr. 14, 2011

(54) OLED DISPLAY PANEL WITH PWM CONTROL

(75) Inventor: Kazuyoshi Kawabe, Tokyo (JP)

(73) Assignee: GLOBAL OLED TECHNOLOGY LLC, Wilmington, DE (US)

(21) Appl. No.: 12/922,660

(22) PCT Filed: Mar. 17, 2009
(86) PCT No.: PCT/US09/01679

§ 371 Date: Dec. 8, 2010

(30) Foreign Application Priority Data
Mar. 19, 2008 (JP) 2008-070550

(51) Int. Cl. G09G 3/32; G09G 5/10

(52) U.S. Cl. 345/691; 345/77

(57) ABSTRACT

A display panel which applies a PWM drive to a drive transistor (2) is provided. A drive transistor supplies current in accordance with its gate voltage, and the current is supplied to a light-emitting element (1) to illuminate the light emitting element. One end of a storage capacitor (6) is connected to the gate of the drive transistor, while the other end thereof is connected to a sweep line (12). A triangular wave which alternately repeats an up phase and a down phase is supplied to the sweep line in order to control an on period of the drive transistor in accordance with the gate voltage, to thereby control light emission of the light-emitting element.

### FIELD OF THE INVENTION

The present invention relates to a display panel having pixels arranged in a matrix.

### BACKGROUND OF THE INVENTION

As organic EL displays are self-emissive, they exhibit high contrast and quick response, making them suitable for video applications such as televisions which display natural images and the like. In general, an organic EL element is driven by way of control elements such as transistors, in which multiple tones are realized by driving transistors with a constant current according to data, or by driving transistors with a constant voltage so as to change the emission period.

In the case of driving transistors with a constant current, as they are used in a saturated region, variation in the characteristics of the transistors such as thresholds and mobility causes variation in the current flowing through an organic EL element, which results in non-uniformity in display. As such, JP 2007-79599A discloses a method of reducing non-uniformity in display by digitally driving transistors in a linear region with a constant voltage.

However, according to the example disclosed in JP 2007-79599 A, in the drive transistor connected in series to the organic EL element, the gate terminal and the drain terminal thereof are diode-connected by a reset transistor, and even when the reset transistor is turned off, the gate potential of the drive transistor varies due to leakage current from the reset transistor. JP 2007-79599A discloses examples for addressing the problem of leakage current, including use of an n-channel transistor as the reset transistor and introduction of LLD (Lightly Doped Drain) structure only to the reset transistor. However, these measures make the manufacturing process of transistors complicated, which makes cost reduction difficult.

### SUMMARY OF THE INVENTION

A display panel according to an aspect of the present invention has pixels arranged in a matrix, each pixel including a drive transistor which supplies current in accordance with a gate voltage, a light-emitting element which emits light by current supplied from the drive transistor, and a storage capacitor having one end connected to the gate of the drive transistor and the other end connected to a sweep line. A triangular wave which alternately repeats an up phase and a down phase is supplied to the sweep line in order to control an on period of the drive transistor in accordance with the gate voltage to thereby control light emission of each pixel.

A display panel according to another aspect of the present invention has pixels arranged in a matrix, each pixel including: a coupling capacitor having one end connected to a data line; a selection transistor having one end connected to the other end of the coupling capacitor and a gate connected to a selection line; a drive transistor which has a gate connected to the other end of the selection transistor and supplies current in accordance with a gate voltage; a light-emitting element which is connected to the drain of the drive transistor and emits light by the current supplied from the drive transistor; a reset transistor having one end connected to a connecting point of the drive transistor and the light-emitting element, the other end connected to a connecting point of the coupling capacitor and the selection transistor, and a gate connected to a reset line; and a storage capacitor having one end connected to a gate of the drive transistor and the other end connected to a sweep line. When the reset transistor and the selection transistor are turned on, the drive transistor is diode-connected so that current flows and a voltage corresponding to the characteristics of the drive transistor is written into the coupling capacitor. Then, in a state that the reset transistor is turned off, the selection transistor is turned on and a voltage of the data line is written into the storage capacitor via the coupling capacitor, and a triangular wave which alternately repeats an up phase and a down phase is supplied to the sweep line in order to control an on period of the drive transistor in accordance with the gate voltage to thereby control light emission.

Further, preferably a light-emission control transistor is arranged between the connecting point of the drain of the drive transistor and the reset transistor, and the light-emitting element, and when the reset transistor is turned on, the light-emission control transistor is turned off.

According to the present invention, an emission period can be controlled, and also current can be controlled effectively according to image data. Further, as the drain of the reset transistor is connected to the gate of the drive transistor via the selection transistor, effects of leakage current from the reset transistor on the gate voltage of the drive transistor can be controlled.

### BRIEF DESCRIPTION OF THE DRAWINGS

FIG. 1 is a diagram showing the configuration of a pixel circuit;

FIG. 2 is a diagram showing states of respective lines when data are written;

FIG. 3 is a diagram illustrating sweeping;

FIG. 4 is a diagram showing circuits for applying a sweep pulse;

FIG. 5A is a diagram showing an example of timing to apply a sweep pulse;

FIG. 5B is a diagram showing another example of timing to apply a sweep pulse;

FIG. 6 is a diagram showing another example of circuits for applying a sweep pulse; and

FIG. 7 is a diagram showing the configuration of a display panel.

### DETAILED DESCRIPTION OF THE INVENTION

Hereinafter, an embodiment of the present invention will be described with reference to the drawings.

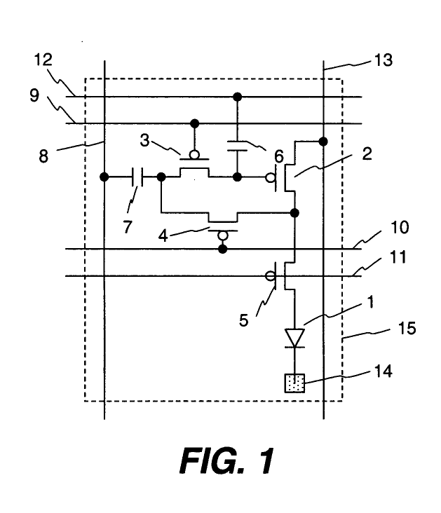

FIG. 1 shows an exemplary configuration of a pixel 15 in a display according to an embodiment. The pixel 15 includes an organic EL element 1, a drive transistor 2, a selection transistor 3, a reset transistor 4, a light-emission control transistor 5, a storage capacitor 6, and a coupling capacitor 7. It should be noted that a P-type thin film transistor is adopted for every transistor.

The drive transistor 2 is configured such that its source terminal is connected to a power source line 13 shared by all pixels, its drain terminal is connected to the source terminal of the light-emission control transistor 5 and to the source terminal of the reset transistor 4, and its gate terminal is connected to one end of the storage capacitor 6 and the source terminal of the selection transistor 3, the other end of the storage capacitor 6 being connected to a sweep line 12. The gate terminal of the selection transistor 3 is connected to a selection line 9, and the drain terminal thereof is connected to one end of the coupling capacitor 7 and the drain terminal of the reset transistor 4, the other end of the coupling capacitor 7 being connected to a data line 8. The gate terminal of the reset transistor 4 is connected to a reset line 10. The gate terminal of the light-emission control transistor 5 is connected to a light-emission control line 11, and the drain terminal thereof is connected to the anode of the organic EL element 1. The cathode of the organic EL element 1 is connected to a cathode electrode 14 shared by all pixels.

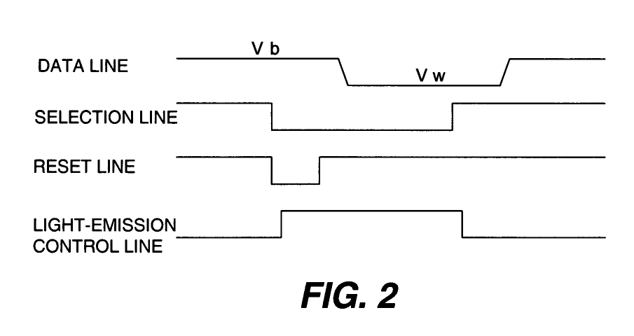

FIG. 2 shows signal waveforms to be input to the data line 8, the selection line 9, the reset line 10, and the light-emission control line 11, for driving the pixel 15. First, when a black level potential Vb is supplied to the data line 8, the selection line 9 and the reset line 4 are turned into low levels, and the selection transistor 3 and the reset transistor 4 are turned on. Thereby, the gate terminal and the drain terminal of the drive transistor 2 are connected (diode-connected), so that a current flows through the organic EL element 1 via the light-emission control transistor 5. Then, when the light-emission control line 11 is turned to a high level, the light-emission control transistor 5 is turned off.

Thereby, the current flowing through the organic EL element flows into the coupling capacitor 7 via the reset transistor 4, and further into the storage capacitor 6 via the selection transistor 3 to thereby shift the gate potential of the drive transistor 2 to a direction in which the current does not flow (direction in which the voltage increases). Thereby, the gate potential of the drive transistor 2 converges near a potential Vdd−Vth which is lower than the power supply potential Vdd of the power source line 13 by a threshold potential Vth.

Then, when the reset line 10 is turned to a high level, the gate potential of the drive transistor 2 is maintained at Vdd−Vth by the storage capacitor 6 and the coupling capacitor 7. In this state, when a white level potential Vw (<Vb) is supplied to the data line 8, the gate potential Vg of the drive transistor 2 becomes Vg=Vdd−Vth−Cc/(Cc+Cs)*(Vb−Vw), where Cc represents the capacitance of the coupling capacitor 7 and Cs represents the capacitance of the storage capacitor 6. Under assumption that Cc is sufficiently larger than Cs, Vg=Vdd−Vth−(Vb−Vw). Consequently, to the gate potential of the drive transistor 2, Vth is automatically applied to offset the difference between the white level and the black level.

When writing of data ends, the selection line 9 is turned to a high level, and the gate potential is stored in the storage capacitor 6 until being selected next time.

Although the selection transistor 3 and the reset transistor 4 are off during the non-selected period, leakage current is likely to be caused in the reset transistor 4. This is because if a black level Vb is written as image data into the pixel 15, the gate potential Vg becomes Vdd-Vth, whereby almost no current flows through the organic EL element 1, so that, although the potential of the source terminal of the reset transistor 4 drops to a potential near the cathode potential VSS, its drain potential remains Vdd-Vth. As such, the potential difference between the source and the drain of the reset transistor 4 is large.

In the pixel 15, as the selection transistor 3 is arranged between the gate terminal of the drive transistor 2 and the drain terminal of the reset transistor 4, even if the drain potential drops due to leakage current of the reset transistor 4, the drop does not affect the gate potential of the drive transistor 2, so that the written gate potential is maintained.

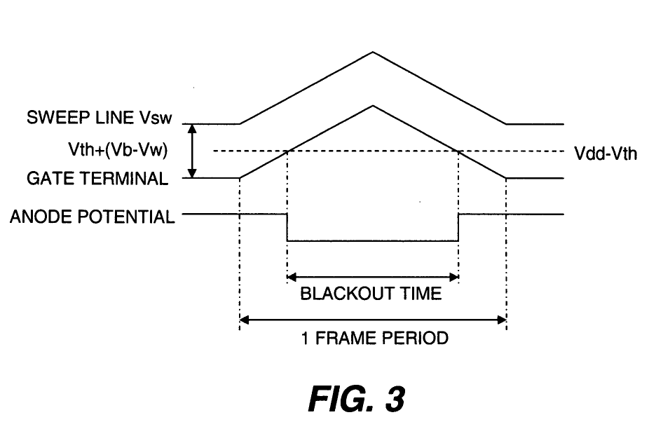

FIG. 3 shows a sweep pulse to be applied to the sweep line after image data are written. After the data are written, a triangular wave is input to the sweep line 12 as shown in FIG. 3. Thereby, the gate potential of the drive transistor 2 varies in the same manner as the sweep line 12 via the storage capacitor 6. If the power supply potential Vdd was supplied to the sweep line 12 when the data were written, a potential difference of Vth+(Vb−Vw) would be written into the storage capacitor 6. Under the assumption that the potential (sweep potential) of the sweep line 12 is Vsw, the gate potential Vg of the drive transistor 2 varies according to Vg=Vsw−Vth−(Vb−Vw). When the sweep potential Vsw is Vdd+(Vb−Vw), the gate potential of the drive transistor 2 becomes Vdd−Vth so that the light goes out. As such, as the difference (Vb−Vw) is larger, the blackout period becomes shorter (emission period becomes longer), and as the difference is smaller, the blackout period becomes longer (emission period becomes shorter). In other words, the emission period can be controlled by the data difference (Vb−Vw) between the white level and the black level input.

Accordingly, by supplying a data voltage corresponding to the brightness of the pixel as a white level Vw, the pixel emits light for a period corresponding to the data. As such, a PMW control for controlling the emission period is performed by the brightness data, and Vth of the drive transistor 2 is also compensated at the same time. Further, in the case of digital drive, both the black level Vb and the white level Vw are supplied as data voltage. Although the white level Vw is constant, it is also possible to compensate for Vth of each drive transistor 2 even in this case.

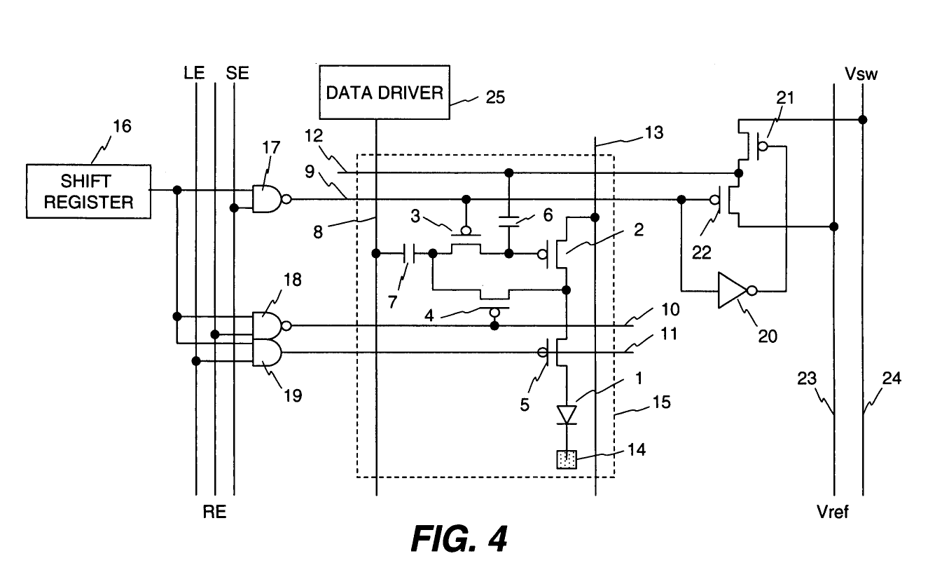

FIG. 4 shows examples of peripheral circuits for supplying a control signal to the data line 8, the selection line 9, the reset line 10, and the light-emission control line 11 of the pixel 15. In general, at least one shift register 16 is provided for the respective lines, and selected data are sequentially shifted from the highest line to lower lines. The output terminal of the shift resister 16 is connected to an input terminal of each of a selection enable circuit 17, a reset enable circuit 18, and a light-emission enable circuit 19. Another input terminal of the selection enable circuit 17 is connected to a selection enable line SE, another input terminal of the reset enable circuit 18 is connected to a reset enable line RE, and another input terminal of the light emission enable circuit 19 is connected to a light-emission enable line LE.

If the selection enable line SE is turned to a high level when selected data of a high level are stored in the shift register 16, the selection line 9 becomes low and is selected. At that time, if the reset enable line RE is turned to a high level, the reset line 10 becomes low, so that the gate terminal and the drain terminal of the drive transistor 2 are connected, whereby current flows into the organic EL element 1.

Then, when the black level potential Vb is supplied from a data driver 25 to the data line 8 so that the light-emission enable line LE is turned to a high level, the light-emission control line 11 becomes high, whereby the current flowing into the organic EL element 1 is interrupted and the threshold potential Vth is written into the storage capacitor 6 and the coupling capacitor 7. When the reset enable line RE is turned to a low level, the reset line 10 becomes high, and the threshold potential Vth is stored in the storage capacitor 6 and the coupling capacitor 7. Then, when image data Vw are supplied from the data driver 25 to the data line 8, data in which Vth is corrected are written into the gate terminal of the drive transistor 2.

Then, when the selected data of a high level, stored in the shift register 16, are shifted to the next stage and data of a low level are stored therein, the selection line 9 is turned to a high level, the reset line 10 is turned to a high level, and the light-emission control line 11 is turned to a low level by the selection enable circuit 17, the reset enable circuit 18, and the light-emission enable circuit 19, respectively, regardless of the states of the selection enable line SE, the reset enable liner RE, and the light-emission enable line LE, whereby the data written in the pixel 15 are stored.

In this writing operation, when the selection line 9 is selected and turned to a low level, the sweep line 12 is connected to a reference potential line 23 to which Vref (Vdd) is supplied, by way of a switch 22. At the same time, as the low potential of the selection line 9 is inverted by an inverter 20 so as to turn a switch 21 off, the sweep line 12 is cut off from a sweep potential line 24 to which the sweep potential Vsw is supplied. When the writing operation ends, the selection line 9 becomes high, and as the switch 22 is turned off, the sweep line 12 is cut off from the reference potential line 23, and the switch 21 is turned on by a signal inverted by the inverter 20, whereby the sweep line 12 is connected to the sweep potential line 24. Thus, the sweep line 12 is fixed only at the time of writing, and when the writing ends, operation to restart sweeping will be repeated.

In the present embodiment, the emission period is controlled by a sweep pulse. If the drive transistor 2 is in a saturated region, the amount of current flowing in the drive transistor 2 is controlled by the analog data voltage and the emission period controlled by the sweep pulse. However, if the drive transistor 2 is in a linear region, as the emission period is digitally controlled, effects exerted by the characteristics of the transistor are reduced. As such, non-uniformity in display can be reduced even with this aspect.

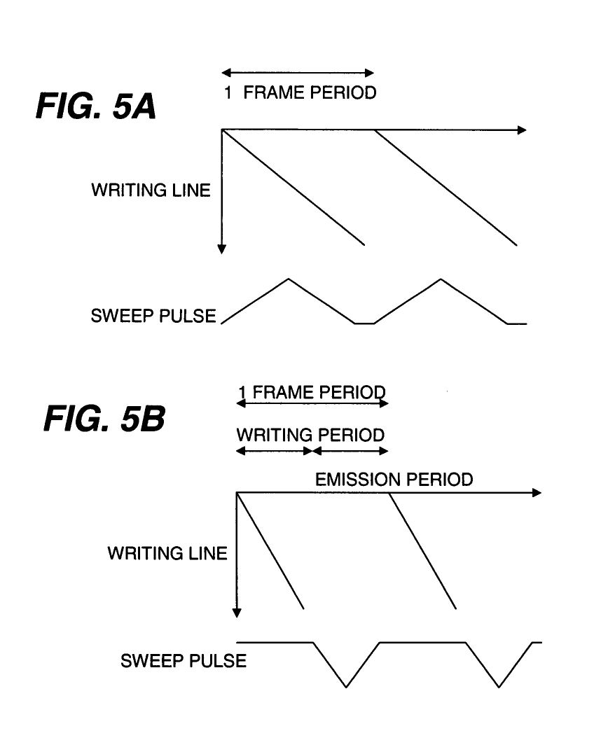

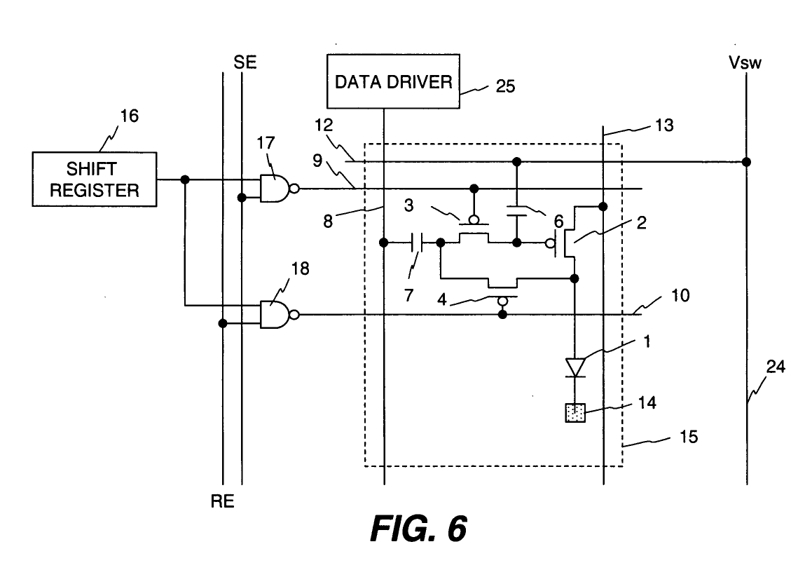

As shown in FIG. 5A, emission control by sweeping may be performed for one frame period by use of the peripheral circuits shown in FIG. 4, or may be divided into two periods as shown in FIG. 5B such that the writing period and the emission period controlled by sweeping are separated. In the example of FIG. 5B, the sweep pulse is maintained at a high level in the writing period during which data are written, in order not to emit light in the pixel during the writing period, and the level of the sweep pulse falls when the writing period ends. In the writing period, if the amplitude ΔVsw of the sweep pulse is added to the white level Vw as an offset so that the data potential Vw′ to be supplied to the data line 8 becomes Vw+ΔVsw, the gate potential Vg of the drive transistor 2 becomes Vg=Vdd−Vth−(Vb−Vw)+ΔVsw. If ΔVsw is larger than (Vb−Vw), the pixel does not emit light during the writing period. As the level of the sweep pulse falls in the emission period, light emission begins, and the emission period is controlled in proportion to (Vb−Vw). In the case where the writing period and the sweep period are separated as shown in FIG. 5B, the switches 21 and 22, the inverter 20, and the reference potential line 23 shown in FIG. 4 may be omitted as shown in FIG. 6. Thus, the only requirement is to produce a triangular wave in the emission period while keeping the sweep potential constant at Vref (Vdd) in the writing period.

Further, the light-emission control transistor 5 may be omitted as in the pixel 15 of FIG. 6. In that case, the light-emission control line 11, the light-emission enable circuit 19, and the light-emission enable line LE can also be omitted, so the pixel circuit and the peripheral circuits are simplified. However, if the light-emission control transistor 5 is omitted, when the selection transistor 3 and the reset transistor 4 are turned on, the potential to be written into the storage capacitor 6 and to the coupling capacitor 7 is not the threshold potential Vth of the drive transistor 2 but a reset potential which is divided by the diode-connected drive transistor 2 and the organic EL element 1. The reset potential is also a potential corresponding to the characteristics of the drive transistor 2, providing the almost same advantages as those described above.

The procedures to write image data after writing the reset potential and sweep the sweep line 12 to emit light are also the same. Further, light emission may be performed by controlling a sweep pulse in one frame period as shown in FIG. 5A by switching potentials to which the sweep line 12 is connected between the time of selecting a line and the time of emitting light, by way of the switches 21 and 22 and the inverter 20.

The sweep pulse is not necessarily a perfect triangular wave, so long as an up phase and a down phase are alternately repeated. The slopes of the up phase and the down phase are not necessarily constant, and may be different between the up phase and the down phase. Further, a period of a constant voltage may exist near the peak. Furthermore, with a waveform which is convex downward, the emission period and the blackout period can be reversed.

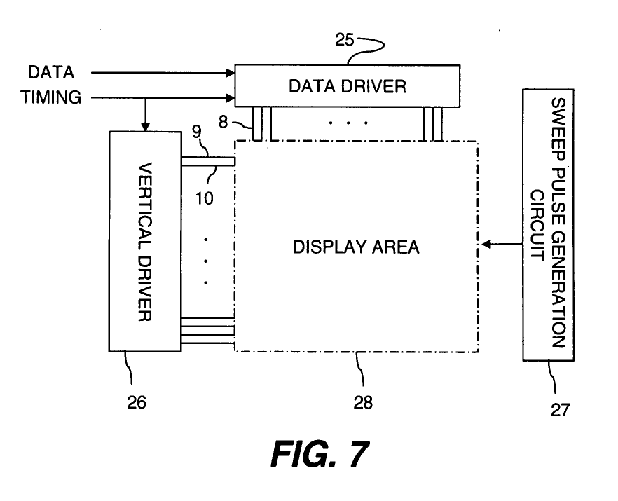

FIG. 7 shows the overall configuration of a display panel. A data signal and a timing signal are supplied to the data driver 25, and are then appropriately supplied to data lines 8 in a row direction, each of which is arranged corresponding to an individual pixel. A vertical driver 26, incorporating the shift register 16, timely controls the voltage of the selection line 9 and the reset line 10.

Each of the selection lines 9 and each of the reset lines 10 is provided corresponding to an individual pixel line. Further, a sweep pulse is generated in a sweep pulse generation circuit 27, and is supplied to each pixel. An area in which pixels are arranged in a matrix is a display area 28.

Although in the above example an organic EL element is adopted as a light-emitting element, other light-emitting elements of current drive type can also be used.

### PARTS LIST

1 element
2 drive transistor
3 selection transistor
4 reset transistor
5 light-emission control transistor
6 storage capacitor
7 coupling capacitor
8 data line
10 reset line
11 light-emission control line
12 sweep line
13 power source line
14 cathode electrode
15 pixel
16 shift register
17 selection enable circuit
18 reset enable circuit
19 light-emission enable circuit
20 inverter
21 switch
22 switch
23 reference potential line
24 sweep potential line
25 data driver
26 vertical driver
27 sweep pulse generation circuit
28 display area

1. A display panel having pixels arranged in a matrix, each pixel comprising:
a drive transistor which supplies current in accordance with a gate voltage;
a light-emitting element which emits light by current supplied from the drive transistor;
a storage capacitor having one end connected to a gate of the drive transistor and another end connected to a sweep line; and
means for applying a triangular wave which alternately repeats an up phase and a down phase to the sweep line to control an on period of the drive transistor in accordance with the gate voltage to thereby control light emission of each pixel.

2. A display panel having pixels arranged in a matrix, each pixel comprising:
a coupling capacitor having one end connected to a data line;
a selection transistor having one end connected to another end of the coupling capacitor and a gate connected to a selection line;
a drive transistor, having a gate connected to another end of the selection transistor, which supplies current in accordance with a gate voltage;
a light-emitting element which is connected to a drain of the drive transistor and emits light by the current supplied from the drive transistor;
a reset transistor having one end connected to a connecting point of the drive transistor and the light-emitting element, another end connected to a connecting point of the coupling capacitor and the selection transistor, and a gate connected to a reset line;
a storage capacitor having one end connected to a gate of the drive transistor and another end connected to a sweep line;
means for turning on the reset transistor and the selection transistor are turned on, the drive transistor is diode-connected so that current flows and a voltage corresponding to a characteristic of the drive transistor is written into the coupling capacitor, and then, in a state that turns off the reset transistor, the selection transistor is turned on and a voltage of the data line is written into the storage capacitor via the coupling capacitor; and
means for applying a triangular wave which alternately repeats an up phase and a down phase to the sweep line i to control an on period of the drive transistor in accordance with the gate voltage to thereby control light emission.

3. The display panel according to claim 2, wherein
a light emission control transistor is arranged between the connecting point of the drain of the drive transistor and the reset transistor, and the light-emitting element, and
when the reset transistor is turned on, the light-emission control transistor is turned off.
